(19) United States
(12) Patent Application Publication
(10) Pub. No.: US 2018/0304167 A1
(43) Pub. Date: Oct. 25, 2018

(54) PERFECT SNOWMAN

(71) Applicant: James Jones, Chicago, IL (US)

(72) Inventor: James Jones, Chicago, IL (US)

(21) Appl. No.: 15/959,247

(22) Filed: Apr. 22, 2018

Related U.S. Application Data
(60) Provisional application No. 62/489,450, filed on Apr. 24, 2017.

(51) Int. Cl. A63H 33/00; F25C 1/22; B29C 43/02; B29C 39/02

(52) U.S. Cl. CPC A63H 33/001; F25C 1/22; F25C 2400/06; B29C 39/028; B29C 43/021

(57) ABSTRACT

A molding system for forming a snowman structured and arranged to stack in tier form, to enable users to create the perfect snowman comprising a straight and sturdy guide to keep the tier in line, users would pack snow into the three-sphere shaped, hinged molds, then open each sphere, revealing three, connected, perfectly sized balls of snow thereby forming a perfectly shaped and symmetrical snowman

### CROSS-REFERENCE TO RELATED APPLICATION

The present application is related to and claims priority from prior provisional application Ser. No. 62/489,450, filed Apr. 24, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of snowman mold devices and more specifically relates to a molding system for forming a snowman structured and arranged to stack in tier form, to enable users to create the perfect snowman comprising a straight and sturdy guide to keep the tier in line, users would pack snow into the three-sphere shaped, hinged molds, then open each sphere, revealing three, connected, perfectly sized balls of snow thereby forming a perfectly shaped and symmetrical snowman

### 2. Description of the Related Art

A snowman is an anthropomorphic snow sculpture often built by children in regions with sufficient snowfall. In many places, typical snowmen consist of three large snowballs of different sizes with some additional accoutrements for facial and other features. Due to the sculpt-ability of snow, there is also a wide variety of other styles. Common accessories include branches for arms and a rudimentary smiley face, with a carrot standing in for a nose. Human clothing, such as a hat or scarf, may be included. Low-cost and availability are the common issues, since snowmen are usually abandoned to the elements once completed.

Snow becomes suitable for packing when it approaches its melting point and becomes moist and compact. Making a snowman of powdered snow is difficult since it will not stick to itself, and if the temperature of packing snow drops, it will form an unusable denser form of powdered snow called crust. Thus, a good time to build a snowman may be the next warm afternoon directly following a snowfall with a sufficient amount of snow. Using more compact snow allows for the construction of a large snowball by simply rolling it until it grows to the desired size. If the snowball reaches the bottom of the grass it may pick up traces of grass, gravel or dirt.

In North America, snowmen are generally built with three spheres representing the head, torso, and lower body. In the United Kingdom, two spheres are used, one sphere representing the body and one representing the head. The usual practice is to then decorate and optionally dress the snowman. Sticks can be used for arms, and a face is traditionally made with stones or coal for eyes and a carrot for a nose. Some like to dress their snowmen in clothing such as a scarf or hat, while others prefer not to risk leaving supplies outdoors where they could easily be stolen or become stuck under melting ice.

Various attempts have been made to solve problems found in snowman mold devices art. Among these are found in: U.S. Pat. No. 7,963,500 to Angela C. Holiday; U.S. Pat. No. 7,264,531 to Ignacio Marc Asperas; and U.S. Pat. No. 5,380,237 to Robert Kenyon. This prior art is representative of snowman mold devices.

Ideally, a molding system for forming a snowman should be user-friendly and safe in-use and, yet would operate reliably and be manufactured at a modest expense. Thus, a need exists for a molding system for forming a snowman structured and arranged to stack in tier form, to enable users to create the perfect snowman comprising a straight and sturdy guide to keep the tier in line, users would pack snow into the three-sphere shaped, hinged molds, then open each sphere, revealing three, connected, perfectly sized balls of snow thereby forming a perfectly shaped and symmetrical snowman and to avoid the above-mentioned problems.

### BRIEF SUMMARY OF THE INVENTION

In view of the foregoing disadvantages inherent in the known of snowman mold device art, the present invention provides a novel molding system for forming a snowman (Entitled the Perfect Snowman). The general purpose of the present invention, which will be described subsequently in greater detail is to provide a molding system for forming a snowman structured and arranged to stack in tier form, to enable users to create the perfect snowman comprising a straight and sturdy guide to keep the tier in line, users would pack snow into the three-sphere shaped, hinged molds, then open each sphere, revealing three, connected, perfectly sized balls of snow thereby forming a perfectly shaped and symmetrical snowman.

A molding system for forming a snowman, comprising: a plurality of molding members, each having a spherical body and a guide member. The spherical body includes an open top portion; an open bottom portion; and two hemispherical halves. Wherein the two hemispherical halves are releasably connected to one another along respective adjacent vertical edges that extend between the open top portion and the open bottom portion. Wherein the plurality of molding members are adapted to be stacked one upon another forming a stack of the plurality of molding members. Wherein the open top and open bottom portions are adapted to align with one another when stacked one upon another, such that when loaded with snow each respective molding member would join together with an adjacent molding member via the snow therein.

Wherein the guide member is adapted to releasably connect with each of the plurality of molding members when the plurality of molding members are stacked one upon another, and adapted to keep the plurality of molding members in a desired vertical alignment until the plurality of molding members are respectively removed from the snow.

The present invention holds significant improvements and serves as a molding system for forming a snowman. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Molding System for Forming a Snowman, constructed and operative according to the teachings of the present invention.

FIG. 1 shows a perspective view illustrating a plurality of molding members molding system for forming a snowman having a plurality of molding members in a closed condition according to an embodiment of the present invention.

FIG. 2 is a perspective view illustrating a plurality of molding members molding system for forming a snowman having a plurality of molding members in a an open condition according to an embodiment of the present according to an embodiment of the present invention of FIG. 1.

FIG. 3 is a perspective view illustrating a guide member located on each of the plurality of molding members of the Molding System for Forming a Snowman according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a snowman mold device and more particularly to a molding system for forming a snowman (Entitled the Perfect Snowman) structured and arranged to stack in tier form, to enable users to create the perfect snowman comprising a straight and sturdy guide to keep the tier in line, users would pack snow into the three-sphere shaped, hinged molds, then open each sphere, revealing three, connected, perfectly sized balls of snow thereby forming a perfectly shaped and symmetrical snowman.

Generally speaking, the Perfect Snowman comprising a novel product offering consumers a practical solution to the aforementioned challenges. As the name implies, the Perfect Snowman is disclosed herein in a preferred embodiment comprising a line of variously sized snowman molds comprised of three spherical pieces arranged in tier form, with the bottom being the largest of the spheres, and the top being the smallest for the snowman's head. Each spherical section would feature an open top and bottom, so that when stacked and loaded with snow, each section would join together with its neighbor, forming a stable snowman. In addition, a sturdy guide would be included which would keep the three spheres in line. One side of each sphere would be split down the center, and the back side of each sphere would be hinged, so that after all three spheres are filled with snow, the doors of each could be opened, and The Perfect Snowman unit removed, revealing The Perfect Snowman.

The Perfect Snowman would offer consumers exactly what they need to create The Perfect Snowman Eliminating the need to start a small snowball from scratch and roll it around until it collects enough snow and grows in size, which can be hard work, not to mention the grass and leaves that can inadvertently wind up sullying your snowman, making him or her look unappealing; instead, with use of The Perfect Snowman, one would simply select The Perfect Snowman in one of the many sizes, set it up, and fill with fresh clean snow. It's that simple! Once packed with snow, the user would simply remove the mold, and voila, The Perfect Snowman. Using the variously sized molds, children and adults alike would love showing off their Snow family creations. Cleverly conceived and thoughtful in design, The Perfect Snowman should be well received by anyone who enjoys making a snowman.

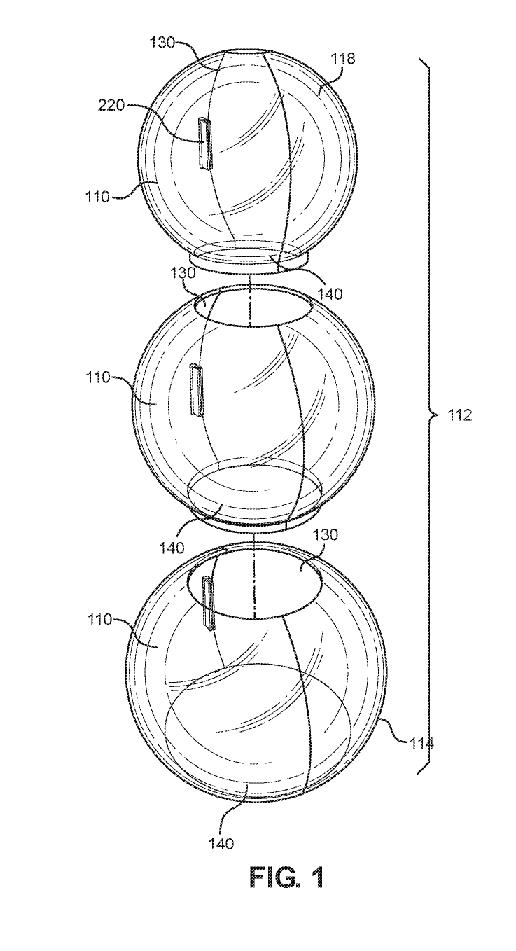

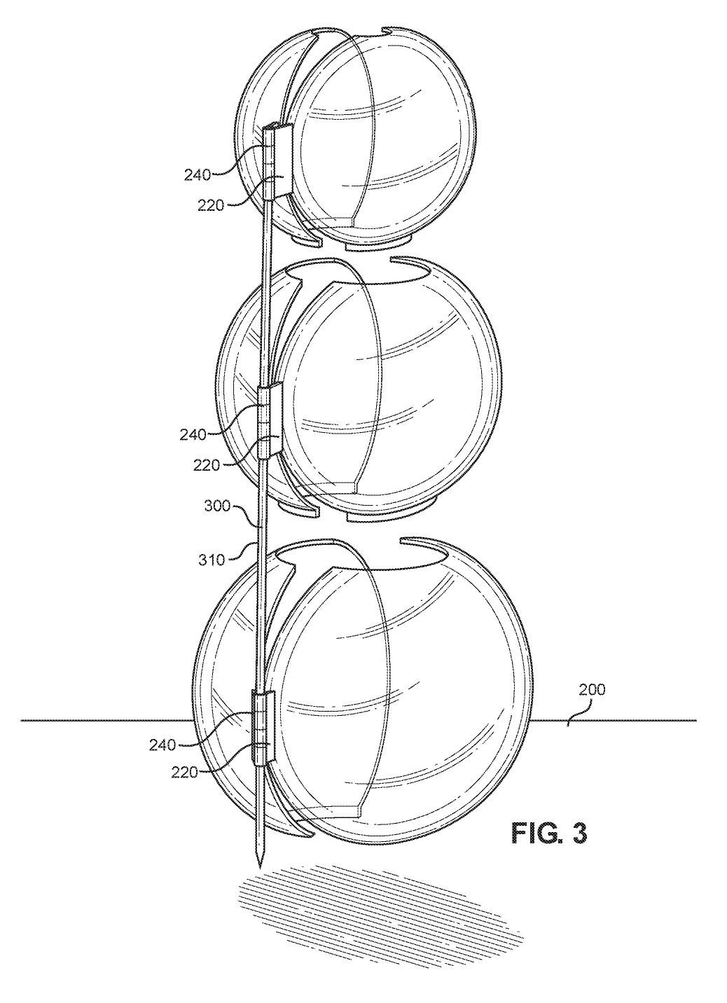

Referring to the drawings by numerals of reference there is shown in FIGS. 1-3, perspective views illustrating molding system 100 for forming snowman 200 according to an embodiment of the present invention.

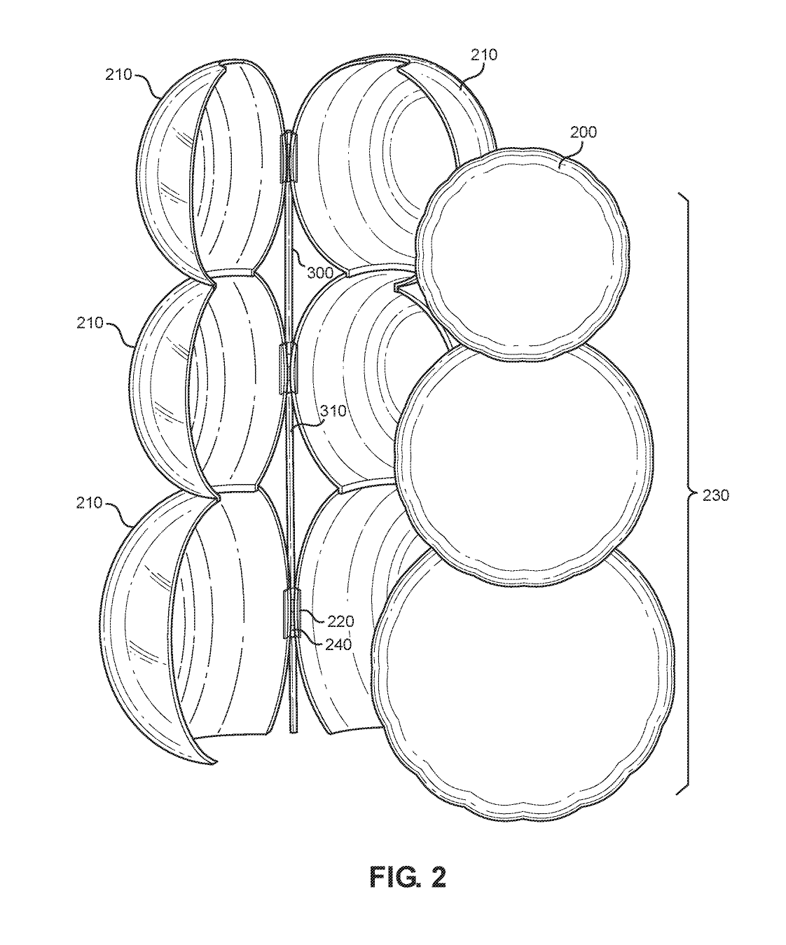

Molding system 100 for forming snowman 200, comprising: plurality of molding members 110, each having spherical body 120 and guide member 300. Spherical body 120 includes open top portion 130; open bottom portion 140; and two hemispherical halves 210. Wherein two hemispherical halves 210 are releasably connected to one another along respective adjacent vertical edges that extend between open top portion 130 and open bottom portion 140. Wherein two hemispherical halves 210 are pivotally connected to one another along one of respective adjacent vertical edges that extend between open top portion 130 and open bottom portion 140. Wherein two hemispherical halves 210 are pivotally connected to one another via hinge member 220 connected therebetween as shown in FIG. 2.

Wherein plurality of molding members 110 are adapted to be stacked one upon another forming stack 230 of plurality of molding members 110. Wherein open top portion 130 and open bottom portions 140 are adapted to align with one another when stacked one upon another, such that when loaded with snow each respective molding member 110 would join together with an adjacent molding member 110 via the snow therein. Wherein plurality of molding members 110 may be formed from a plastic material. Wherein plurality of molding members 110 may also be formed from a ceramic material. Wherein plurality of molding members 110 may also be formed from a metallic material.

Wherein there are three molding members 112, such that resulting molded snow resembles three-section snowman 200. Wherein plurality of molding members 110 are formed in successive sizes, such that largest molding member 114 is adapted to be placed at the bottom of stack 230 of plurality of molding members 110, smallest molding member 118 is adapted to be placed at the top of stack 230 of plurality of molding members 110, and any intervening molding members 110 are placed between largest 114 and smallest 118 molding members 118 in successive sizes from largest to smallest. Wherein there are three molding members 112; and wherein three molding members 112 are formed in three successive sizes, such that largest 114 of three molding members 112 is adapted to be placed at the bottom of stack 230 of plurality of molding members 110, smallest 118 of three molding members 112 is adapted to be placed at the top of stack 230 of plurality of molding members 110, and the intervening one of three molding members 112 is placed between largest 114 and smallest 112 molding member 110.

Wherein guide member 300 is adapted to releasably connect with each of plurality of molding members 110 when plurality of molding members 110 are stacked one upon another, and adapted to keep plurality of molding members 110 in a desired vertical alignment until plurality of molding members 110 are respectively removed from the snow.

Wherein 300 includes elongated guide rod 310 adapted to extend vertically between each of plurality of molding members 110; and wherein each hinge member 220 includes tubular hinge pin 224 adapted to allow elongated guide rod 310 to pass therethrough; wherein respective ones of each of plurality of molding members 110 are adapted to respectively slide down upon elongated guide rod 310 one on top of another. Wherein elongated guide rod 310 is adapted to be at least partially inserted into ground surface 350 before plurality of molding members 110 are placed thereon. Wherein elongated guide rod 310 includes sharpened distal end portion 320 adapted to pierce ground surface 350 and aid in elongated guide rod 310 being at least partially inserted into ground surface 350.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A molding system for forming a snowman, comprising:
a plurality of molding members, each including:
a spherical body including;
an open top portion;
an open bottom portion;
two hemispherical halves;
wherein said two hemispherical halves are releasably connected to one another along respective adjacent vertical edges that extend between said open top portion and said open bottom portion;
wherein said plurality of molding members are adapted to be stacked one upon another forming a stack of said plurality of molding members; and
wherein said open top and open bottom portions are adapted to align with one another when stacked one upon another, such that when loaded with snow each respective molding member would join together with an adjacent molding member via the snow therein; and
a guide member;
wherein said guide member is adapted to releasably connect with each of said plurality of molding members when said plurality of molding members are stacked one upon another, and adapted to keep said plurality of molding members in a desired vertical alignment until said plurality of molding members are respectively removed from said snow.

2. The molding system of claim 1, wherein said two hemispherical halves are pivotally connected to one another along one of said respective adjacent vertical edges that extend between said open top portion and said open bottom portion.

3. The molding system of claim 2, wherein said two hemispherical halves are pivotally connected to one another via a hinge member connected therebetween.

4. The molding system of claim 3, wherein said guide member includes an elongated guide rod adapted to extend vertically between each of said plurality of molding members; and wherein each said hinge member includes a tubular hinge pin adapted to allow said elongated guide rod to pass therethrough; wherein respective ones of each of said plurality of molding members are adapted to respectively slide down upon said elongated guide rod one on top of another.

5. The molding system of claim 4, wherein said elongated guide rod is adapted to be at least partially inserted into a ground surface before said plurality of molding members are placed thereon.

6. The molding system of claim 5, wherein said elongated guide rod includes a sharpened distal end portion adapted to pierce said ground surface and aid in said elongated guide rod being at least partially inserted into said ground surface.

7. The molding system of claim 1, wherein said plurality of molding members are formed from a plastic material.

8. The molding system of claim 1, wherein said plurality of molding members are formed from a ceramic material.

9. The molding system of claim 1, wherein said plurality of molding members are formed from a metallic material.

10. The molding system of claim 1, wherein there are three molding members, such that said resulting molded snow resembles a three-section snowman.

11. The molding system of claim 1, wherein said plurality of molding members are formed in successive sizes, such that the largest molding member is adapted to be placed at the bottom of said stack of said plurality of molding members, the smallest molding member is adapted to be placed at the top of said stack of said plurality of molding members, and any intervening molding members are placed between said largest and smallest molding members in successive sizes from largest to smallest.

12. The molding system of claim 11, wherein there are three molding members; and wherein said three molding members are formed in three successive sizes, such that the largest of said three molding member is adapted to be placed at the bottom of said stack of said plurality of molding members, the smallest of said three molding member is adapted to be placed at the top of said stack of said plurality of molding members, and the intervening one of said three molding members is placed between said largest and smallest molding member.
